(19) United States
(12) Patent Application Publication
(10) Pub. No.: US 2004/0139164 A1
(43) Pub. Date: Jul. 15, 2004

(54) Apparatus and method for visually reporting job progressing condition

(76) Inventor: Kohich Kanaya, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/692,745

(22) Filed: Oct. 27, 2003

(30) Foreign Application Priority Data
Nov. 1, 2002 (JP) 2002-320052

(51) Int. Cl. G06F 15/16; G06F 12/14; H04L 9/32; G06F 11/30

(52) U.S. Cl. 709/206; 709/229; 713/200

(57) ABSTRACT

An image processing apparatus is connected to a network by a LAN and is operative to perform printing and copying jobs upon a request from a user. The image processing apparatus includes a thumbnail image data generating device generating thumbnail image data of a first page of the job. An electronic mail transmitting device is included in the image processing apparatus to transmit an electronic mail having a thumbnail image data of the first page to a mail address of the user when the job is completed or interrupted in the digital copier.

### CROSS REFERENCE TO RELATED APPLICATION

This document claims priority under 35 U.S.C. §119 to Japanese Patent Application No. 2002-320052 filed on Nov. 01, 2002, the entire contents of which are hereby incorporated herein by reference.

### BACKGROUND OF THE INVENTION

1. Field of the Invention

The present specification relates to a job progress reporting method and apparatus employed in a network environment, in which a digital copier, a printer, and a terminal apparatus are connected to the network via a local area network (LAN), and in particular to a job progress reporting method and apparatus capable of visually reporting a job progressing condition from the digital copier to a remote terminal via the network.

2. Discussion of the Background

Utilizing a network infrastructure connecting various components, such as a digital copier, a printer, a scanner, etc., to a network via a LAN is rapidly spreading in business environments. In such an environment, a plurality of terminal apparatuses (e.g. client workstations of personal computers) each having a network connection function share these components in increasingly various manners. For example, when a printer is utilized through the network in such a conventional sharing manner, a terminal apparatus issues a printing job request to the printer as a job issuance source, and then receives various reports on a job such as completion, error, ongoing, etc., from the printer.

A background art, Japanese Patent Application Laid Open Number 2001-216105, discusses that a personal computer connected to a network transmits printing data to a printer connected to a network by a device other than an electronic mail. The printer then extracts an electronic mail address of the printing job issuance source from the printing data, and then sends prescribed information thereto by the electronic mail.

Another background art, Japanese Patent Application Laid Open number 2000-200226, discusses that a scanner connected to a network reads and transmits image data of an original document to a printer via the network, and the printer copies the image data on a sheet. Further, the background art enables reporting a copy job status in a scanner or printer to an electronic mail destination previously registered in the scanner.

However, admitting that a remote terminal apparatus can receive such reports as in the above-mentioned patent publications, the present inventors realized it is hard for an operator operating the terminal apparatus to identify such a job merely from the received reports.

### SUMMARY OF THE INVENTION

Accordingly, an object of the present invention is to address and resolve such and other problems and provide a novel image processing apparatus that is connected to a network and is operative to perform printing and copying jobs upon a request from a user. The image processing apparatus includes a thumbnail image data generating device generating thumbnail image data of a first page of the job, and an electronic mail transmitting device transmitting an electronic mail having the thumbnail image data of the first page to a mail address of the user when the job is completed or interrupted.

In another embodiment, the electronic mail includes only a URL representing an information source to a mail address assigned to the terminal apparatus when at least one of the jobs is completed or interrupted.

In yet another embodiment, the mail address is associated with a user code and the image processing apparatus is operable when the user code is input and authenticated.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates a digital copier connected to a network according to a preferred embodiment of the present invention;

FIG. 2 illustrates a sheet conveyance path included in the digital copier;

FIG. 3 illustrates a control unit also included in the digital copier;

FIG. 4 illustrates a system control section and an image processing section included in the digital copier;

FIG. 5 illustrates an operational flow used when a copy job progressing condition is reported from the digital copier to a remote terminal through the network;

FIG. 6 illustrates an input screen provided in the digital copier for allowing a user to input a job;

FIG. 7 also illustrates a screen provided in the digital copier for allowing a user to input a job reporting request;

FIG. 8 illustrates a screen appearing when the digital copier is ready to copy;

FIG. 9 illustrates a correspondence between a user and a mail address;

FIG. 10 illustrates an exemplary screen displaying the job progressing report together with a thumbnail; and

FIGS. 11A and 11B also illustrate an exemplary screen displaying the job progressing report together with a URL of a thumbnail source.

### DESCRIPTION OF THE PREFERRED EMBODIMENTS

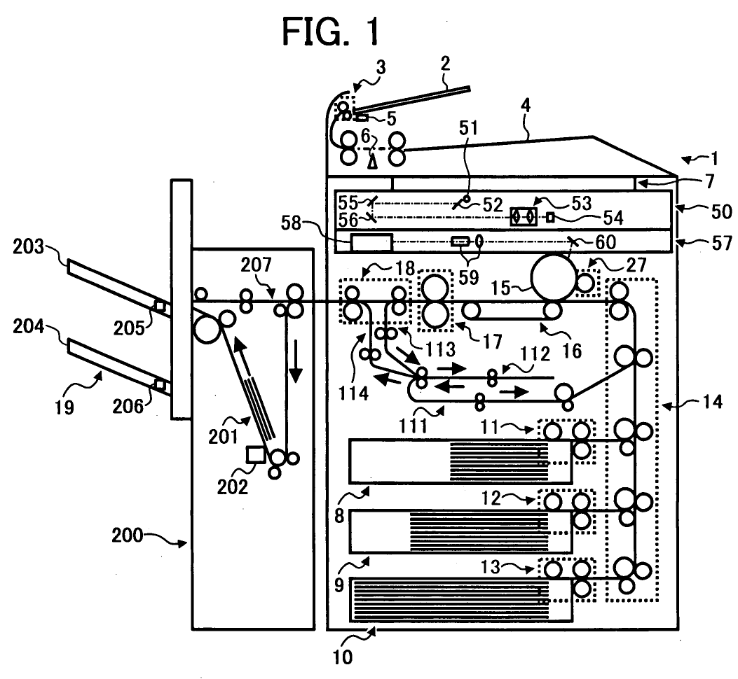

Referring now to the drawings, wherein like reference numerals designate identical or corresponding parts throughout the several views, and in particular to FIG. 1, a digital copier includes a reading unit 50 scanning and reading an original document set on an original document table 2. The reading unit 50 includes an optical scanning unit and an exposure platen 7 receiving the original document thereon. The optical unit includes an exposure lamp 51, a first mirror 52, a lens 53, and a CCD type image sensor 54 and similar parts. The exposure lamp 51 and first mirror 52 are secured to a first carriage (not shown). The second and third mirrors 55 and 56 are secured to a second carriage (not shown). When an original image is read, the first carriage is mechanically moved and scans faster by two times than the second carriage to maintain a prescribed optical path length. Such an optical scanner is driven by a scanner driving motor (not shown). The CCD type image sensor 54 simultaneously reads and converts the original image into an electric signal.

The digital copier also includes an automatic original document feeder (ADF) 1 reading a sheet such as an original document. The ADF 1 feeds the original document set on the original document table 2 toward an original document reading sensor 6 by feeding rollers 3. When passing through the original document reading sensor 6 at a constant speed, the original document is read by the original document reading sensor 6. Image data is obtained and is then subjected to various image processing operations, such as MTF correction, filtering, compression, etc. The image data is stored one after another in an image memory. The original document reading sensor 6 may include a contact type full magnification CCD. As shown, the digital copier also includes a writing unit 57 having a laser output unit 58, an imaging lens 59, and a mirror 60. The laser output unit 58 includes a laser diode as a laser light source and a polygon mirror rotated by a motor at a constant high speed. A laser light is irradiated from the writing unit 57 to a photo-conductive (PC) member 15 included in an image formation system.

A procedure of printing an image on the PC member 15 is now described. First, a transfer sheet stacked on one of first, second, and third respective trays 8, 9, and 10 is fed by corresponding ones of first, second, and third sheet feeding apparatuses 11, 12, and 13. The transfer sheet is then conveyed by a sheet conveyance unit 14 until it contacts the PC member 15. A laser light transmitted from the writing unit 57 writes image data stored in the memory on the PC member 15. A toner image is then formed when the image data passes through the developing unit 27. The transfer sheet receives a transfer of the toner image while being conveyed by the conveyance belt 16 at the same speed as the PC member 15. Subsequently, the fixing unit 17 fixes the toner image to the transfer sheet. A sheet ejection unit 18 then ejects the transfer sheet onto a sheet ejection tray 19. The fixing unit 17 is enabled to perform fixing after warming up for a few seconds by thinning its roller and employing a large power heater therein.

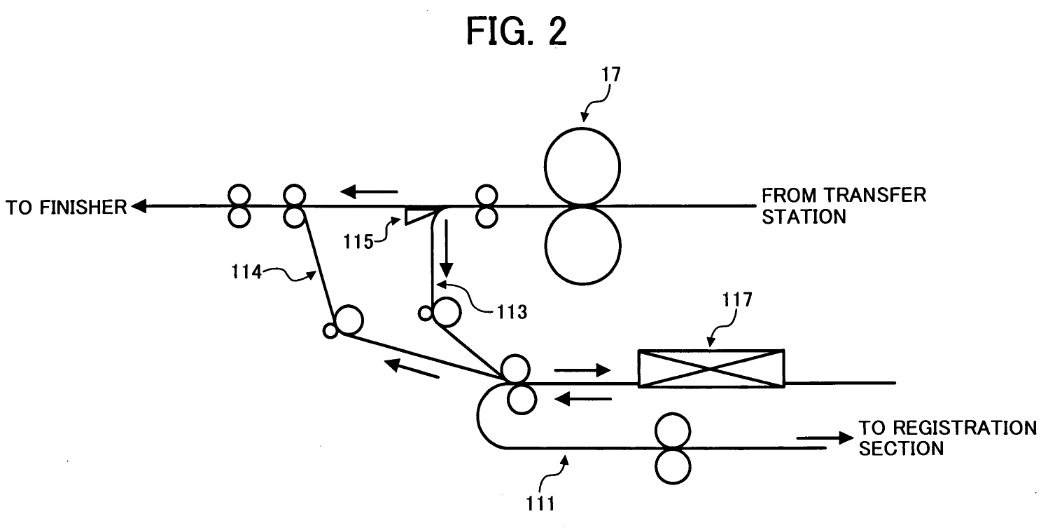

When a duplex copy is formed on a transfer sheet, a transfer sheet fed from one of the sheet feeding trays 8 to 10 and then carrying an image on one of its sides is conveyed into a duplex sheet entering conveyance route 113 detouring away from the sheet ejection tray 19 when an inversion route switching pick 115 (FIG. 2) is switched to a prescribed position, shown in FIGS. 1 and 2. The transfer sheet then switches back at the inversion unit 112, and is conveyed toward a duplex conveyance unit 111 with its left and right sides being aligned by a sheet jogger 117. The transfer sheet in the duplex conveyance unit 111 is then conveyed to a vertical conveyance unit 14 and receives printing of an image on the other side, and is then ejected. Further, when the transfer sheet is simply inverted and ejected from the copier body, the transfer sheet having switched back at the inversion unit 112 is launched into an inversion sheet ejection route 114 and is ejected.

Further, a transfer sheet can be ejected to a finisher 200 from the copier body. To perform a staple operation in the finisher 200, the transfer sheets can be temporary stacked onto a staple stack tray 201. When all of the desired number of transfer sheets are stored on the staple stack tray 201, such a sheet bundle is stapled by a stapler unit 202, and is ejected either onto an upper or lower election tray 203 or 204. In contrast, when the stapling is not needed, the transfer sheet passes through a straight sheet ejection conveyance route 207, and is similarly ejected onto either the ejection tray 203 or 204. If the ejection trays 203 and 204 are enabled to move up and down, a transfer sheet conveyed from either a straight sheet ejection conveyance route 207 or the staple stack tray 201 is selectively ejected onto one of those trays 203, 204. Further, sheet detecting devices 205 and 206 can be employed in the respective sheet ejection trays 203 and 204 to detect a remaining number of transfer sheets that have been printed.

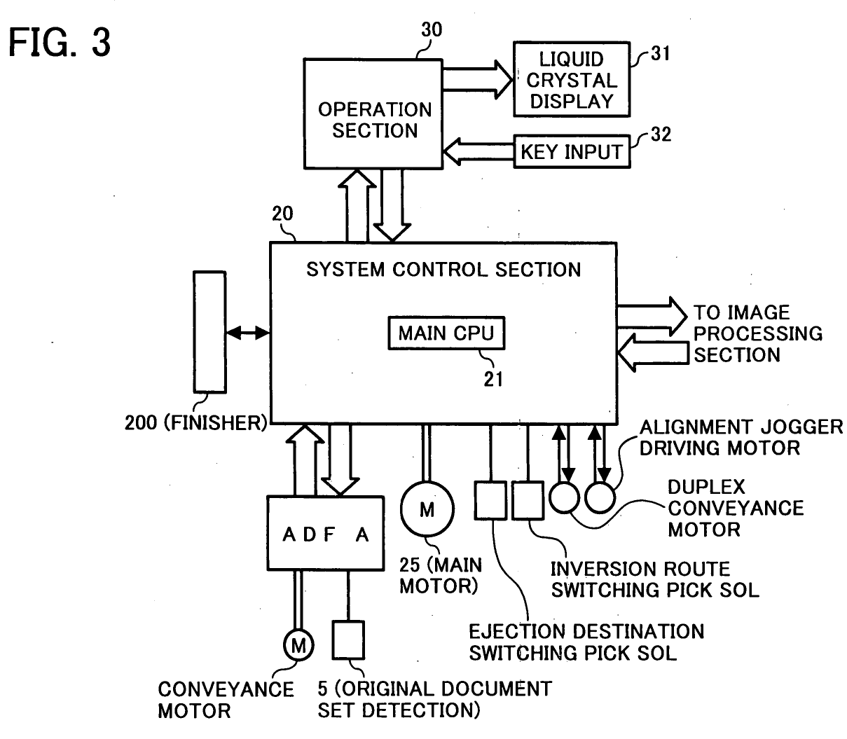

A control unit controlling such a digital copier is now described with reference to FIG. 3. As shown in FIG. 3, the control unit includes a system control section 20 including a main CPU 21. The main CPU controls an operation section 30, a liquid crystal display 31, and a key inputting section 32 to input information and output a display. The main CPU also controls the ADF 1, the finisher unit 200, and various loads such as a main motor 25, etc. to operate.

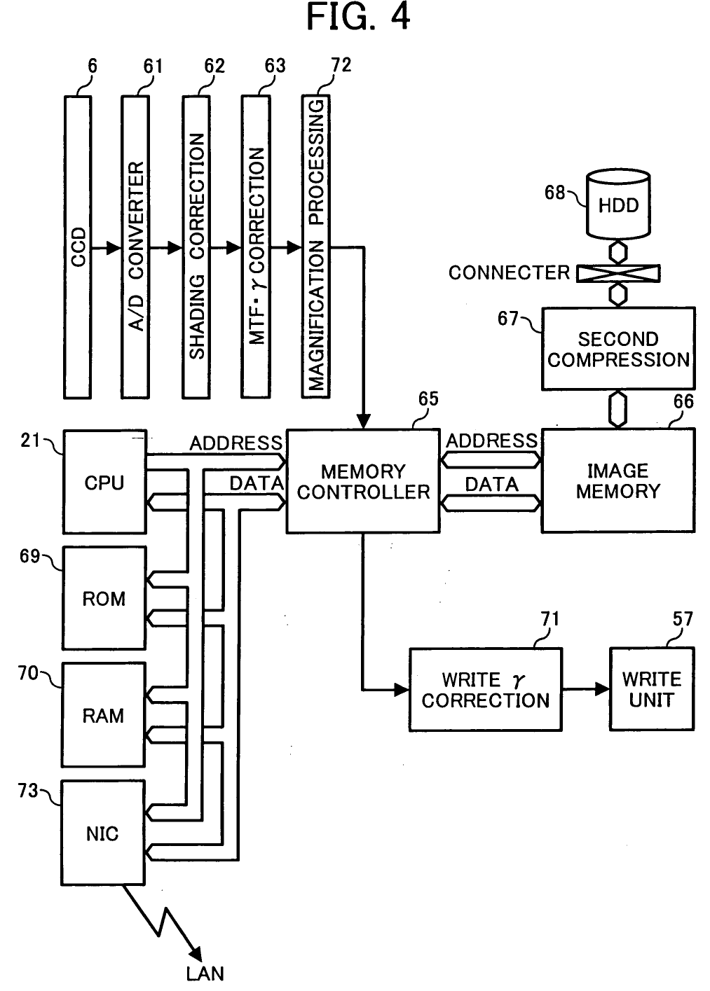

The system control section 20 and an image processing section are now described with reference to FIG. 4. As shown in FIG. 4, an image signal read by the original document reading sensor (e.g. a CCD) 6 may be converted into a digital signal by an A/D converter 61. The digital signal is then subjected to various processes, such as MTF, γ-corrections, etc., from the respective shading correction section 62 and MTF γ-correction section 63. The image data processed by a magnification processing section 72 is enlarged or reduced in accordance with a magnification ratio, and is then transferred to an image memory controller 65. The image data receives primary compression processing in the memory controller 65 and is then written into the image memory 66 to form a bitmap. Operations performed heretofore are continued until all the pages are written into a memory once an original document is started to be read. Bitmap image data (i.e., the image data) of the image memory 66 receives secondary compression from a secondary compression section 67, and is then written into a hard disk HDD 68. Such an operation cannot be synchronized with reading and writing of the image data from the original document into the image memory 66.

Specifically, when the image data is stored in the image memory 66 and the HDD is in a standby state, the bitmap image can be transferred to the HDD 68 at an optional time. Thumbnail image data is simultaneously generated in a multipurpose image format such as “jpeg”, “tiff”, etc., per a page of the image data written in the image memory 66, or only for a leading page, and is then stored in the HDD 68. Such thumbnail image data is obtained, for example, by thinning each pixel data mapped (aligned) to an image, in both main and sub scanning (horizontal or vertical) directions on a page.

Further, when image data written in the image memory 66 is printed, the image data is transferred from the image memory 66 to the memory controller 65. The image data is then transmitted to the writing unit 57 via the write γ correction unit 71. The image data transferred to the writing unit 57 then forms a latent image on the PC member 15 and is developed, and thereby a copy image is obtained. When the image is not printed (i.e., the image is simply stored in the HDD 68), such a printing operation is omitted.

Further, the system control section 20 includes a ROM 69, a RAM 70, and a network interface controller (NIC) 73 beside the main CPU 21. The main CPU 21 analyzes printing details written in a page description language (PDL) and converts those into bitmap image data when a printing request is received via the network and NIC 73. Further, the main CPU 21 writes the bit map image data in the image memory 66 and stores the same in the HDD 68 after applying secondary compression thereto. Similar to when copying, the main CPU 21 stores thumbnail image data in the HDD 68 in the “tiff” format and similar as in the case of the bit map image data. Further, the NIC 73 includes an electronic mail protocol (i.e., a communication procedure). Thus, both a mail address of the digital copier and transmission details can be transmitted to an external network in accordance with the electronic mail protocol. The NIC 73 includes a function of a web page server, i.e., information of each page is linked in a network. Thus, when a page is requested to be displayed, an HTML file generated for a plurality of pages can be transmitted to a request source together with job progressing in the digital copier, such as job completion, interruption, abnormality, etc.

Thus, a thumbnail image generating device can be realized in this embodiment by the main CPU 21, and a transmitting device can be realized by the NIC 73.

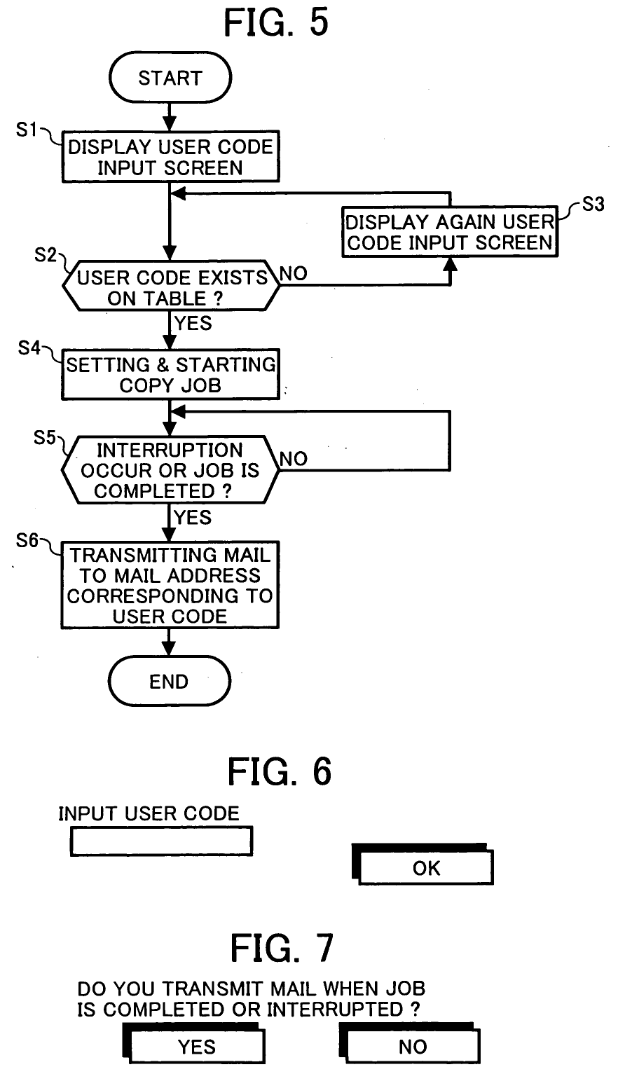

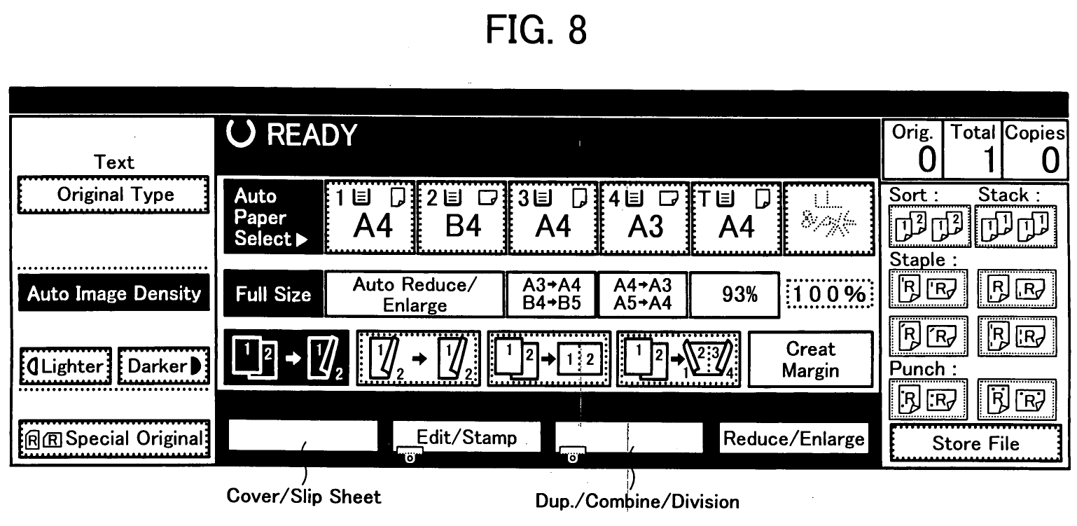

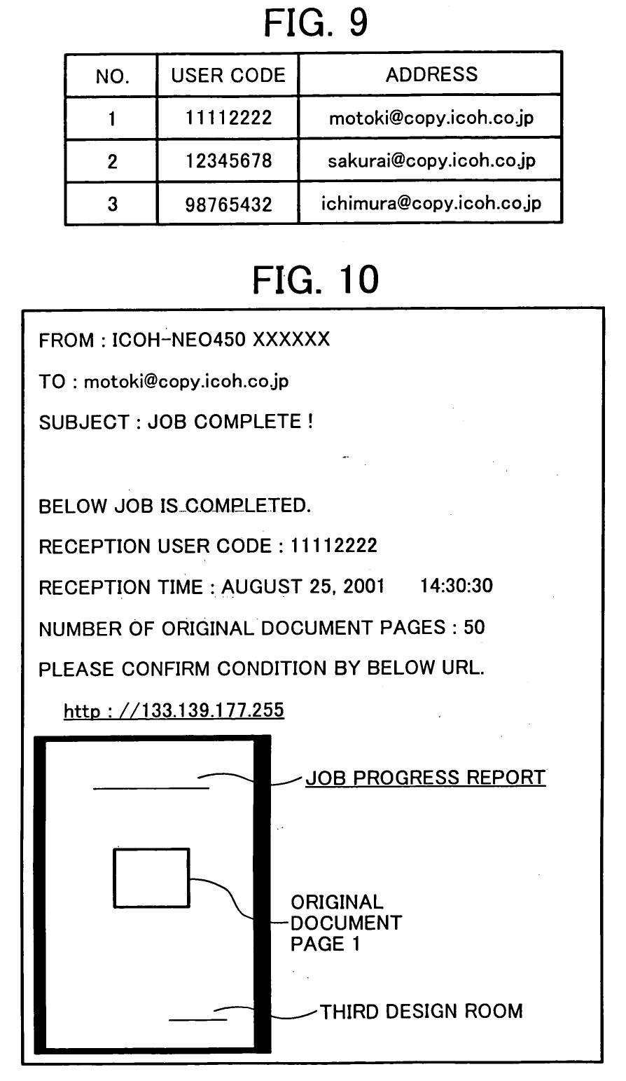

An operation of a copy job designated through a key input section 32 of the digital copier and an operational flow executed when progress of the copy job is reported via the network are now described with reference to FIG. 5. When a copy operation is started, messages promoting a user to input a user code (e.g. a numerical number) are displayed on a screen of the LCD 31 as shown in FIG. 6 (in step S1). When the user inputs the user code through the key input section 32, the main CPU 21 compares it with user codes listed on a user code table (see FIG. 9) previously registered in the HDD 68 and read in the RAM 70 (in step S2). Thus, the user code serves as an authentication number restricting users. A copy only becomes available when such a number exists on the user code table. If the input user code does not exist on the user code table (No, in step S2), the screen of FIG. 6 is displayed again to promote the user to input the user code again (in step S3). In contrast, if the input user code exists on the user code table (Yes, in step S2), the CPU 21 displays a screen allowing the user to designate and request transmission of a job progressing condition report mail (see FIG. 7). Then, if the user selects an indication “Yes” or “No”, information representing the selection result is stored and a copy ready screen is simultaneously displayed as shown in FIG. 8. Then, a prescribed copy job is set and starts (in step S4). When the copy job is completed or interrupted (Yes, in step S5), and when “Yes” has been selected in the above, an electronic mail is transmitted to a mail address corresponding to the user code previously input together with a thumbnail image as shown in FIG. 10 (in step S6). For example, when a code “11112222” is input for the user code, the electronic mail is transmitted to the corresponding address motoki@copy.icoh.co.jp. As shown in FIG. 10, a reception user code, a job progressing condition information (e.g. “completion”), a reception time, a number of original documents, and a URL of a digital copier and so on are included in the electronic mail. A thumbnail image of a first page of a job is also attached thereto. As a result, the user can readily exactly identify a digital copier and a completed or interrupted job when receiving the mail, particularly as the user can view the thumbnail image of the copy job. The above-mentioned operation is explained on the premise that a job is a copying by a digital copier. However, similar effects can be obtained when the job is printing. Specifically, a printing job request is similarly transmitted to a digital copier from a terminal apparatus together with a user code (or a mail address).

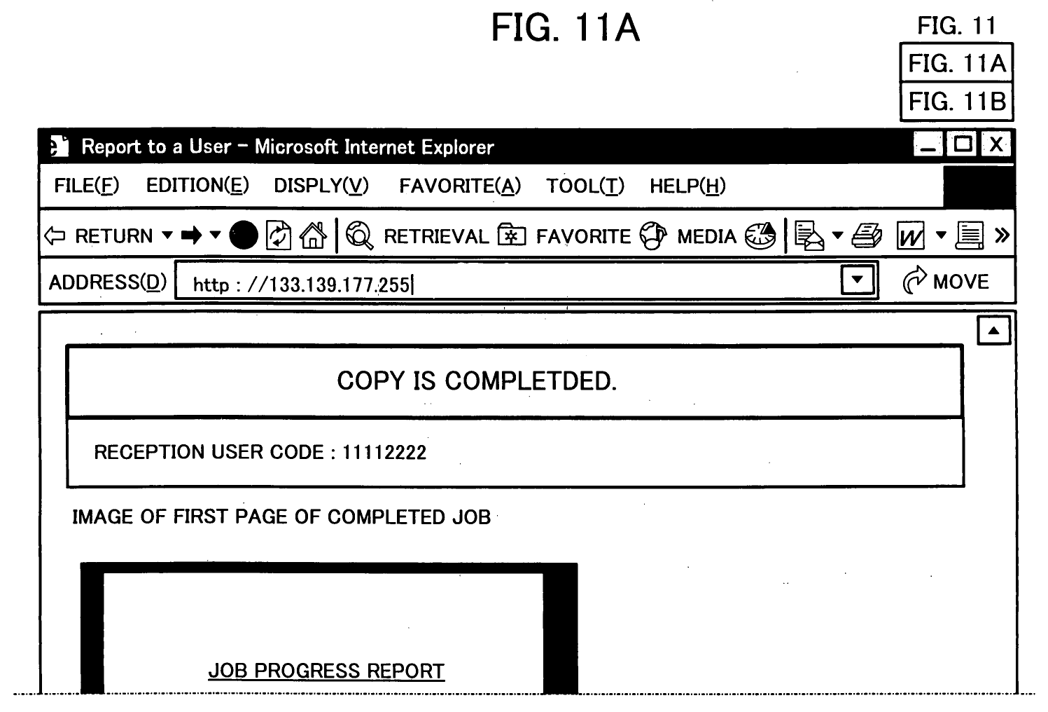

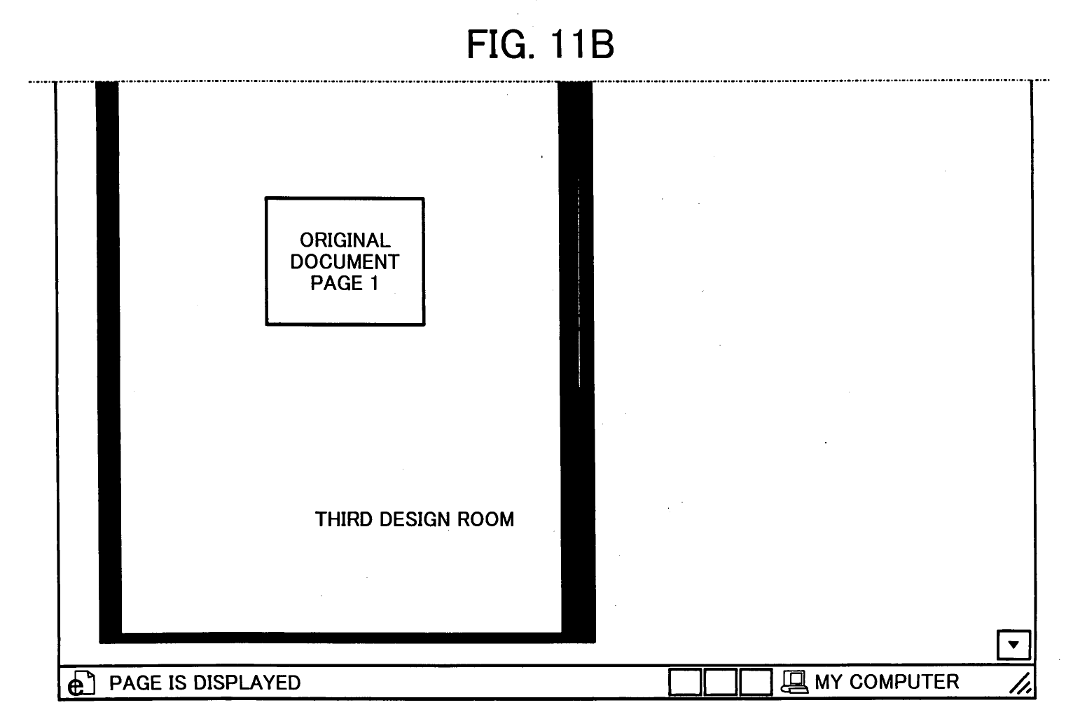

Further, as shown in FIGS. 11A and 11B, when a designated copying or printing job is completed or interrupted by some reason, an electronic mail can be transmitted to a terminal apparatus having a designated mail address, describing a job progressing condition information such as completion, interruption, etc., together with a URL of the digital copier without a thumbnail image data. The terminal apparatus can then access an information source defined by the URL by giving instructions through a displayed browser, and obtain and display a thumbnail image data of a first page of the job from the information source.

Obviously, numerous additional modifications and variations of the present invention are possible in light of the above teachings. It is therefore to be understood that within the scope of the appended claims, the present invention may be practiced otherwise than as specifically described herein.

1. An image processing apparatus connected to a network and operative to perform printing and copying jobs upon a request from a user, said image processing apparatus comprising:
a thumbnail image data generating device configured to generate thumbnail image data of a first page of a job; and
an electronic mail transmitting device configured to transmit an electronic mail having the thumbnail image data of the first page to a mail address of the user when the job is completed or interrupted.

2. The apparatus of claim 1, wherein the mail address is associated with a user code representing a user, and wherein the image processing apparatus is operable when the user code is input and authenticated.

3. The apparatus of claim 2, wherein the user code is authenticated by accessing a user code table listing users permitted to request the job.

4. An image processing apparatus connected to a network and operative to perform printing and copying jobs upon a request from a user, said image processing apparatus comprising:
generating means for generating thumbnail image data of a first page of a job; and
transmitting means for transmitting an electronic mail having the thumbnail image data of the first page to a mail address of the user when the job is completed or interrupted.

5. The apparatus of claim 4, wherein the mail address is associated with a user code representing a user, and wherein the image processing apparatus is operable when the user code is input and authenticated.

6. The apparatus of claim 4, wherein the user code is authenticated by accessing a user code table listing user permitted to request the job.

7. An image processing apparatus connected to a network and operative to report a job progressing condition to a terminal apparatus requesting a job by the network, said image processing comprising:
a controller configured to determine if at least one job is completed or interrupted in the image processing apparatus;
a thumbnail image data generating device configured to generate thumbnail image data of a first page of the job, wherein said thumbnail image data is stored in an information source provided in the image processing apparatus;
an electronic mail transmitting device configured to transmit an electronic mail having a URL representing the information source to a mail address assigned to the terminal apparatus when the job is completed or interrupted;
a controller configured to allow the terminal apparatus having the mail address to access the information source by a browser displayed on the terminal apparatus, and to allow the terminal apparatus to obtain the thumbnail image data.

8. The apparatus of claim 7, wherein said mail address is associated with a user code representing a user, wherein said image processing apparatus is operable when the user code is input and authenticated.

9. The apparatus of claim 8, wherein the user code is authenticated by accessing a user code table listing users permitted to request the job.

10. An image processing apparatus connected to a network and operative to report a job progressing condition to a terminal apparatus requesting thereto a job by the network, said image processing comprising:
means for determining if at least one job is completed or interrupted in the image processing apparatus;
means for generating thumbnail image data of a first page of the job, wherein said thumbnail image data is stored in an information source provided in the image processing apparatus;
means for transmitting an electronic mail having a URL representing the information source to a mail address assigned to the terminal apparatus when the job is completed or interrupted;
means for allowing the terminal apparatus having the mail address to access the information source by a browser displayed on the terminal apparatus; and for allowing the terminal apparatus to obtain the thumbnail image data.

11. The apparatus of claim 10, wherein said mail address is associated with a user code representing a user, and wherein said image processing apparatus is operable when the user code is input and authenticated.

12. The apparatus of claim 11, wherein the user code is authenticated by accessing a user code table listing users permitted to request the job.

13. A method for reporting, by a network, a job progressing condition in an image processing apparatus performing printing and copying jobs upon a request of a user, said method comprising:
determining if at least one of the jobs is completed or interrupted in the image processing apparatus;
generating thumbnail image data of a first page of the job; and
transmitting an electronic mail having the thumbnail image data to a mail address of the user when at least one of the jobs is completed or interrupted.

14. The method of claim 13, wherein said mail address is associated with a user code representing a user, and wherein said image processing apparatus is operable when the user code is input and authenticated.

15. The method of claim 14, wherein the user code is authenticated by accessing a user code table listing users permitted to request the job.

16. A method for reporting a job progressing condition in an image processing apparatus to a terminal apparatus requesting thereto a job by a network, said method comprising:
determining if at least one job is completed or interrupted in the image processing apparatus;
generating thumbnail image data of a first page of the job, wherein said thumbnail image data is stored in an information source provided in the image processing apparatus;
transmitting an electronic mail having a URL representing the information source to a mail address assigned to the terminal apparatus when the job is completed or interrupted;
allowing the terminal apparatus having the mail address to access the information source by a browser displayed on the terminal apparatus; and
allowing the terminal apparatus to obtain the thumbnail image data.

17. The method of claim 16, wherein said mail address is associated with a user code representing a user, and wherein said image processing apparatus is operable when the user code is input and authenticated.

18. The method of claim 17, wherein the user code is authenticated by accessing a user code table listing users permitted to request the job.
